(19) United States
(12) Patent Application Publication
(10) Pub. No.: US 2024/0411043 A1
(43) Pub. Date: Dec. 12, 2024

(54) HIGH-RESOLUTION REFLECTION IMAGING WITH LARGE-SCALE RESERVOIR AND STRUCTURE DETERMINATION USING FULL-WAVEFORM SONIC DATA

(71) Applicant: BRIAN EDWARD HORNBY, Fulshear, TX (US)

(72) Inventor: BRIAN EDWARD HORNBY, Fulshear, TX (US)

(73) Assignee: Hornby Geophysical Services, LLC, Fulshear, TX (US)

(21) Appl. No.: 18/738,556

(22) Filed: Jun. 10, 2024

Related U.S. Application Data
(60) Provisional application No. 63/472,085, filed on Jun. 9, 2023.

(51) Int. Cl. G01V 1/50; E21B 47/002; E21B 47/0224

(52) U.S. Cl. CPC G01V 1/50; E21B 47/0025; E21B 47/0224; E21B 43/26; G01V 1/44; G01V 1/48; G01V 2210/6222; G01V 2210/74

(57) ABSTRACT

Systems and methods for forming sonic images of a subterranean region and disclosed. The method may include acquiring, using a borehole sonic tool, a full-waveform sonic dataset pertaining to a borehole penetrating the subterranean region receiving the full-waveform sonic dataset, obtaining a sonic velocity model pertaining to the subterranean region, and obtaining a trajectory for the borehole, wherein the trajectory characterizes a spatial path of the borehole through the subterranean region in a first coordinate system, and transforming the sonic velocity model from the first coordinate system into a second coordinate system. The method further includes forming a sonic image in the second coordinate system from the sonic velocity model in the second coordinate system and the full-waveform sonic dataset, transforming the sonic image from the second coordinate system into the first coordinate system; and identifying a location of a sonic reflector within the sonic image.

### CROSS REFERENCE TO RELATED APPLICATIONS

This application claims priority to U.S. Provisional Application Ser. No. 63/472,085 filed Jun. 9, 2023, entitled “HIGH-RESOLUTION REFLECTION IMAGING WITH LARGE-SCALE RESERVOIR AND STRUCTURE DETERMINATION USING FULL-WAVEFORM SONIC DATA”, hereby incorporated by reference.

### FIELD

This present application relates to borehole sonic logging and, more particularly, to improved reflection sonic imaging and characterization of formation structures and other changes away from the borehole.

### BACKGROUND

Borehole sonic logging tools have sound transmitters and receivers that are primarily designed to record signals with which to estimate formation velocity along the borehole, for both compressional (P-wave) and shear wave (S-wave) arrivals. In addition to these primary arrivals, reflected signals bouncing off (reflecting from) formation changes (interfaces) located at a distance from the borehole may be recorded. Reflection sonic imaging uses these reflected signals in full-waveform sonic data to reveal structural or pore-fluid changes beyond the borehole. This structural and pore-fluid information may be used by engineers to help target borehole completions and locations and inform the drilling of future wells.

Accurate and detailed velocity models are required for high-resolution sonic imaging, yet conventional methods typically rely only on spatially restricted information acquired at the borehole. Further, conventional methods use a static velocity model, that does not use information gleaned from the sonic imaging process itself. Improved methods for obtaining accurate and detailed velocity models, integrating information from the sonic imaging process remains a pressing need.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In general, in one aspect, embodiments relate to a method. for forming sonic images of a subterranean region. The method may include acquiring, using a borehole sonic tool, a full-waveform sonic dataset pertaining to a borehole penetrating the subterranean region, wherein the borehole sonic tool comprises at least one source and at least one receiver, and using a sonic processing system, receiving the full-waveform sonic dataset, obtaining a sonic velocity model pertaining to the subterranean region, and obtaining a trajectory for the borehole, wherein the trajectory characterizes a spatial path of the borehole through the subterranean region in a first coordinate system. The method may further include transforming the sonic velocity model from the first coordinate system into a second coordinate system, forming a sonic image in the second coordinate system from the sonic velocity model in the second coordinate system and the full-waveform sonic dataset, and transforming the sonic image from the second coordinate system into the first coordinate system. The method may still further include identifying, using a sonic interpretation workstation, a location of a sonic reflector within the sonic image.

In general, in one aspect, embodiments relate to a system for forming sonic images of a subterranean region, including a borehole sonic tool, a sonic processing system, and a sonic interpretation workstation. The borehole sonic tool may be configured to acquire a full-waveform sonic dataset pertaining to a borehole penetrating the subterranean region, wherein the borehole sonic tool comprises at least one source and at least one receiver. The sonic processing system may be configured to receive the full-waveform sonic dataset, receive a sonic velocity model pertaining to the subterranean region, receive a trajectory for the borehole, wherein the trajectory characterizes a spatial path of the borehole through the subterranean region in a first coordinate system. The sonic processing system may be also configured to transform the sonic velocity model from the first coordinate system into a second coordinate system, form a sonic image in the second coordinate system from the sonic velocity model in the second coordinate system and the full-waveform sonic dataset, and transforming the sonic image from the second coordinate system into the first coordinate system. The sonic interpretation workstation may be configured to identify the location of a sonic reflector within the sonic image.

Other aspects and advantages of the claimed subject matter will be apparent from the following description and the appended claims.

### BRIEF DESCRIPTION OF THE DRAWINGS

Specific embodiments of the disclosed technology will now be described in detail with reference to the accompanying figures. Like elements in the various figures are denoted by like reference numerals for consistency.

FIG. 1 depicts a borehole logging system in accordance with one or more embodiments.

FIG. 2 depicts a borehole drilling system in accordance with one or more embodiments.

FIG. 3 depicts a borehole sonic tool deployed in a borehole penetrating a formation in accordance with one or more embodiments.

FIG. 4 shows borehole sonic waveforms recorded in a borehole penetrating a formation in accordance with one or more embodiments.

FIG. 5 depicts reflected ray paths penetrating a formation in accordance with one or more embodiments.

FIG. 6 shows a flowchart in accordance with one or more embodiments.

FIG. 7 shows a portion of full-waveform dataset recorded in a borehole penetrating a geological formation in accordance with one or more embodiments.

FIG. 8 depicts a sonic velocity model and borehole trajectory for a subsurface region of the earth in accordance with one or more embodiments.

FIGS. 9A & 9B depict sonic velocity models in a borehole-centric coordinate system in accordance with one or more embodiments.

FIGS. 10A & 10B depict travel time tables in accordance with one or more embodiments.

FIGS. 11A & 11B depict travel time tables in accordance with one or more embodiments.

FIGS. 12A & 12B depict sonic images in accordance with one or more embodiments.

FIG. 13 depicts sonic images in accordance with one or more embodiments.

FIG. 14 depicts sonic images in accordance with one or more embodiments.

FIG. 15 depicts sonic velocity model in accordance with one or more embodiments.

FIG. 16 depicts sonic images in accordance with one or more embodiments.

FIG. 17 depicts a high-resolution earth model of a Geomechanics property, Young's modulus, in accordance with one or more embodiments.

FIG. 18 depicts a flowchart in accordance with one or more embodiments.

These drawings illustrate certain aspects of some examples of the present disclosure and should not be used to limit or define the disclosure

### DETAILED DESCRIPTION

In the following detailed description of embodiments of the invention, numerous specific details are set forth in order to provide a more thorough understanding of the disclosure. However, it will be apparent to one of ordinary skill in the art that the disclosure may be practiced without all of these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as using the terms “before,” “after,” “single,” and other such terminology. Rather, the use of ordinal numbers is to distinguish between the elements. By way of an example, a first element should be understood to be distinct from a second element, and the first element may encompass more than one element and succeed (or precede) the second element in an ordering of elements.

It is to be understood that the singular forms “a,” “an,” and “the” include plural referents unless the context clearly dictates otherwise. Thus, for example, reference to “a receiver” includes reference to one or more of such receivers.

Terms such as “approximately,” “substantially,” etc., mean that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

It is to be understood that one or more of the steps shown in the flowcharts may be omitted, repeated, and/or performed in a different order than the order shown. Accordingly, the scope disclosed herein should not be considered limited to the specific arrangement of steps shown in the flowcharts.

Although multiple dependent claims are not introduced, it would be apparent to one of ordinary skill that the subject matter of the dependent claims of one or more embodiments may be combined with other dependent claims.

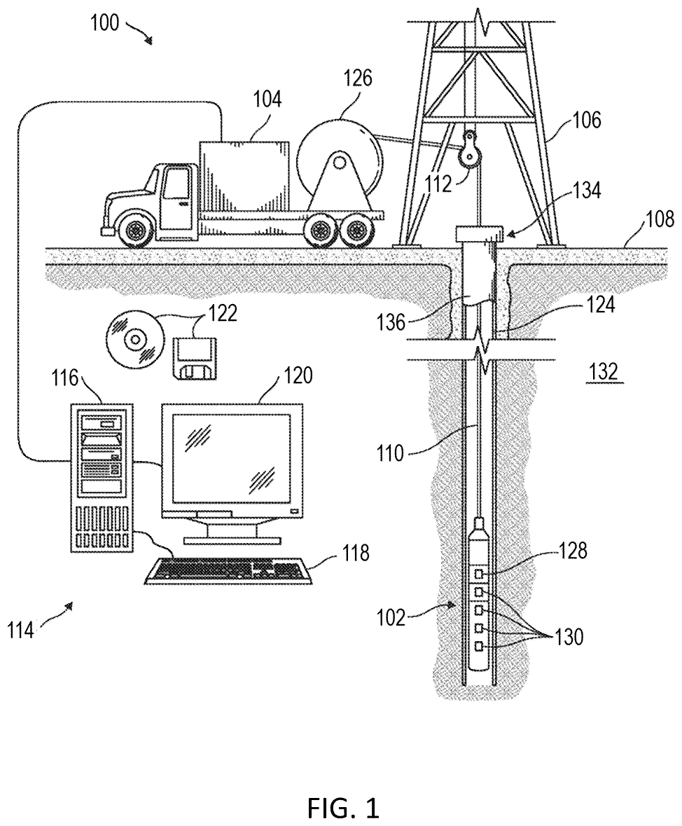

In the following description of FIGS. 1-18, any component described regarding a figure, in various embodiments disclosed herein, may be equivalent to one or more like-named components described regarding any other figure. For brevity, descriptions of these components will not be repeated regarding each figure. Thus, each and every embodiment of the components of each figure is incorporated by reference and assumed to be optionally present within every other figure having one or more like-named components. Additionally, in accordance with various embodiments disclosed herein, any description of the components of a figure is to be interpreted as an optional embodiment which may be implemented in addition to, in conjunction with, or in place of the embodiments described regarding a corresponding like-named component in any other figure.

Reference will now be made to the exemplary embodiments illustrated in the drawings and specific language will be used herein to describe the same. It will nevertheless be understood that no limitation of the scope of the invention is thereby intended. Alterations and further modifications of the inventive features illustrated herein and additional applications of the principles of the inventions as illustrated herein, which would occur to one skilled in the relevant art and having possession of this disclosure, are to be considered within the scope of the invention.

For reflection imaging it is well known in surface seismic imaging efforts that computing an accurate velocity model for the imaging process is key to success of the imaging. Borehole sonic imaging has historically been processed using the recorded compressional or shear-wave velocity to create a 1D velocity model. This model ignores any known changes in formation dip away from the well and essentially assumes that the beds crossing the well are orthogonal to the borehole with a relative dip of 0 degrees. Here relative dip is defined as a measurement of the bedding angle crossing the borehole relative to a plane orthogonal to the borehole. And so, for a vertical well crossing a horizontal bed boundary the relative dip is 0 degrees. If, for example, the bedding is flat and the borehole is horizontal, then the relative dip is 90 degrees. For the case of bedding with a relative dip of 0 degrees, there is no imaging target for borehole sonic imaging as there are no structure changes away from the borehole to reflect signals back to the borehole. In practice relative dips of 30 degrees or more are needed to get reflected signals useful for reflection imaging, with strongest signals at high angles up to 90 degrees relative dip. The effect of this assumption for cases where relative dip is high enough to deliver useful reflections from bedding away from the borehole the resulting image will be distorted as the structural assumption of the velocity model is quite different from the actual geology.

Recent efforts have looked at using the measured relative dip of the bedding crossing the borehole using borehole wall imaging measurements to drive the formation of a 2D velocity model away from the well. This can result in an improved image for bedding crossing the borehole, but some challenges exist. First—the near-borehole structure intersected by the borehole may be different from one side of the borehole to the other. Second—the bedding for the case of dipping beds crossing the borehole may not simply travel in a straight line away from the well but may well travel in a curved or other shape. For example, if the borehole is changing direction with increasing depth that will cause the bedding to change dip in a curved manner as a function of depth away from the well. Next, and most important, for horizontal or near horizontal wells, there may be little or no information from borehole wall imaging logs that can be used to generate the velocity model needed for reflection imaging as the beds of interest for reflection imaging away from the well may either not intersect the borehole at all or may intersect only on occasion as the borehole simply will not pass the bedding except momentarily in the case the borehole passes down into a reservoir or momentarily as the borehole goes out of the reservoir zone and then back into it. And so in for these extended-reach horizontal wells there can be thousands of feet of borehole passage where the formations away from the borehole do not intersect the borehole in any meaningful way with the result the velocity model cannot be correctly configured by using recorded or processed borehole information.

The invention disclosed herein, focuses on improved process for determining images of geologic structures away from a borehole using sonic reflections recorded in full-waveform sonic data. Such geological structures may or may not intersect the borehole and may be imaged at locations a few feet to 100 feet or more from the borehole.

In accordance with one or more embodiment, a method for borehole sonic imaging may include collecting a full-waveform sonic dataset that samples a subsurface region of interest and obtaining or creating a large scale 2-dimensional (2D), or even three-dimensional (3D) velocity model describing the velocity (P-wave or S-wave) of the earth. Such a model may integrate velocities determined using all available full-waveform sonic data from well of interest and any available offset wells and may typically be stored and presented in a cartesian coordinate system with one axis indicating depth below the surface of the earth and the remaining axis/axes indicating one or more horizontal axes. A local velocity model for the portion of earth surrounding the borehole up to the maximum distance desired from the borehole may be formed from the velocity model. A coordinate transform may be used to transform the local velocity model from the multi-dimensional (normally 2D) velocity model referenced to cartesian coordinates to a local velocity model referenced to the borehole axis. Using this velocity model geological structure may be imaged away from the borehole using a pre-stack depth imaging code, such as Reverse-Time Migration imaging, or using pre-stack ray tracing solutions such as Generalized Radon Transform.

In some embodiments the image of geological structure may be transformed back into the cartesian coordinate system for display and interpretation and to inform decision making and execution relating to the drilling of future boreholes and the completion of the borehole from which the borehole sonic full-waveform dataset was recorded. Such interpretation may include modifying or updating the velocity model in view of the images geological structure followed by iterative creation of a local velocity model in a borehole-centric coordinate system and the forming of an updated image of geological structure. Herein, a borehole-centric coordinate system refers to a with one axis parallel or tangential to the borehole trajectory and a second axis perpendicular to the first axis.

In other embodiments the image of geological structure may be interpreted, the local velocity model updated in view of the interpretation, and the image of the geological structure revised in an iterative loop all in the borehole-centric coordinate system. In this instance the image of geological structure may only be transformed back into cartesian coordinates once a stable, “converged” image of the geological structures surround the borehole is obtained.

In either of the embodiments described in the preceding, or others not explicitly described, the interactive sequence of imaging, determining geological structure, updating the local velocity model, followed by further imaging may be repeated until a stable image, little changing over one iteration to the next, is obtained.

The advantage of this procedure, over conventional methods, is that the velocity model is not fixed, for example from recorded sonic velocity data along the well, but uses information derived from the geometry and location of geological structure extending away from the borehole to revise the velocity model for imaging. Note, in some cases the geological structure may never intersect the borehole and its presence and influence on the local velocity model may only be deduced from the image of the geological structure determined during earlier iterations. In other cases geological structure, such as bedding, may intersect or cross the borehole differences and embodiments are provided here in to separately image the structure on either side of the borehole.

For extended-reach horizontal wells, for example, it is of interest to visualize the location of reservoir boundaries away from the well to a high resolution to guide borehole drilling and borehole completion and so development of a good velocity mode is critical to achieve good results. For multiple target reservoirs away from the well it will be particularly important to get the velocity model right.

The sonic images of geological structure in the vicinity of the borehole may be used directly and indirectly for a multitude of practical applications. The images may be used to plan the completion of the borehole, such as where to cement steel casing into the borehole, where to perforate the steel casing to allow the influx of fluids and/or where to hydraulically fracture the wellbore. As a specific example, engineers may determine not to perforate segments of casing used to line the borehole where the borehole trajectory approaches to closely a fluid interface, particularly an oil water interface, to avoid sucking the (unwanted) water into a producing borehole. Similarly, engineers may elect to cement casing into portions of a borehole that cross a geological fault to provide maximum structural strength to the borehole.

Alternatively, the image of the geological structure may be used indirectly to plan and drill future wells. For example, it may be observed that portions of the borehole closely approaching the reservoir seal (the top of the reservoir) are correlated with portions exhibiting higher than average electrical resistivity. Thus, when subsequent boreholes are drilled, the electrical resistivity may be monitored in real time by sensors near the drill bit, and the borehole steered into the regions higher than average electrical resistivity under the reasonable inference that such regions are near the top of the reservoir.

The preceding two scenarios are just two simplified examples of the many practical uses for the sonic images of geological structure extending away from the borehole and are presented for illustration only and are not intended to limit the scope of the invention in any way.

FIG. 1 illustrates a cross-sectional view of a borehole sonic logging system 100. As illustrated, borehole sonic logging system 100 may comprise a borehole sonic logging tool 102 attached to a vehicle 104. In examples, it should be noted that borehole sonic logging tool 102 may not be attached to a vehicle 104. Borehole sonic logging tool 102 may be supported by rig 106 at surface 108. Borehole sonic logging tool 102 may be tethered to vehicle 104 through conveyance 110. Conveyance 110 may be disposed around one or more sheave wheels 112 to vehicle 104. Conveyance 110 may include any suitable means for providing mechanical conveyance for borehole sonic logging tool 102, including, but not limited to, wireline, slickline, coiled tubing, pipe, drill pipe, downhole tractor, or the like. In some embodiments, conveyance 110 may provide mechanical suspension, as well as electrical connectivity, for borehole sonic logging tool 102. Conveyance 110 may comprise, in some instances, a plurality of electrical conductors extending from vehicle 104. Conveyance 110 may comprise an inner core of seven electrical conductors covered by an insulating wrap. An inner and outer steel armor sheath may be wrapped in a helix in opposite directions around the conductors. The electrical conductors may be used for communicating power and telemetry between vehicle 104 and borehole sonic logging tool 102.

Information from borehole sonic logging tool 102 may be gathered and/or processed by information handling system 114. For example, signals recorded by borehole sonic logging tool 102 may be stored on memory and then processed by borehole sonic logging tool 102. The processing may be performed real-time during data acquisition or after recovery of borehole sonic logging tool 102. Processing may alternatively occur downhole or may occur both downhole and at surface. In some embodiments, signals recorded by borehole sonic logging tool 102 may be conducted to information handling system 114 by way of conveyance 110. Information handling system 114 may process the signals, and the information contained therein may be displayed for an operator to observe and stored for future processing and reference. Information handling system 114 may also contain an apparatus for supplying control signals and power to borehole sonic logging tool 102.

Systems and methods of the present disclosure may be implemented, at least in part, with information handling system 114. Information handling system 114 may include any instrumentality or aggregate of instrumentalities operable to compute, estimate, classify, process, transmit, receive, retrieve, originate, switch, store, display, manifest, detect, record, reproduce, handle, or utilize any form of information, intelligence, or data for business, scientific, control, or other purposes. For example, an information handling system 114 may be a processing unit 116, a network storage device, or any other suitable device and may vary in size, shape, performance, functionality, and price. Information handling system 114 may include random access memory (RAM), one or more processing resources such as a central processing unit (CPU) or hardware or software control logic, ROM, and/or other types of nonvolatile memory. Additional components of the information handling system 114 may include one or more disk drives, one or more network ports for communication with external devices as well as various input and output (I/O) devices, such as a input device 118 (e.g., keyboard, mouse, etc.) and a video display 120. Information handling system 114 may also include one or more buses operable to transmit communications between the various hardware components.

Alternatively, systems and methods of the present disclosure may be implemented, at least in part, with non-transitory computer-readable media 122. Non-transitory computer-readable media 122 may include any instrumentality or aggregation of instrumentalities that may retain data and/or instructions for a period of time. Non-transitory computer-readable media 122 may include, for example, storage media such as a direct access storage device (e.g., a hard disk drive or floppy disk drive), a sequential access storage device (e.g., a tape disk drive), compact disk, CD-ROM, DVD, RAM, ROM, electrically erasable pro-grammable read-only memory (EEPROM), and/or flash memory; as well as communications media such wires, optical fibers, microwaves, radio waves, and other electro-magnetic and/or optical carriers; and/or any combination of the foregoing.

As illustrated, borehole sonic logging tool 102 may be disposed in borehole 124 by way of conveyance 110. The borehole 124 may follow a trajectory through the subterranean region. For example, the trajectory may describe the spatial path of the borehole in depth and one or two horizontal space dimensions. Borehole 124 may extend from a wellhead 134 into a formation 132 from surface 108. Generally, borehole 124 may include horizontal, vertical, slanted, curved, and other types of borehole geometries and orientations. Borehole 124 may be cased or uncased. In examples, borehole 124 may comprise a metallic material, such as tubular 136. By way of example, the tubular 136 may be a casing, liner, tubing, or other elongated steel tubular disposed in borehole 124. As illustrated, borehole 124 may extend through formation 132. Borehole 124 may extend generally vertically into formation 132. However, borehole 124 may extend at an angle through formation 132, such as horizontal and slanted well-bores. For example, although borehole 124 is illustrated as a vertical or low inclination angle well, high inclination angle or horizontal placement of the well and equipment may be possible. It should further be noted that while borehole 124 is generally depicted as a land-based operation, those skilled in the art may recognize that the principles described herein are equally applicable to subsea operations that employ floating or sea-based platforms and rigs, without departing from the scope of the disclosure.

In examples, rig 106 includes a load cell (not shown) which may determine the amount of pull on conveyance 110 at surface 108 of borehole 124. While not shown, a safety valve may control the hydraulic pressure that drives drum 126 on vehicle 104 which may reel up and/or release conveyance 110 which may move borehole sonic logging tool 102 up and/or down borehole 124. The safety valve may be adjusted to a pressure such that drum 126 may only impart a small amount of tension to conveyance 110 over and above the tension necessary to retrieve conveyance 110 and/or borehole sonic logging tool 102 from borehole 124. The safety valve is typically set a few hundred pounds above the amount of desired safe pull on conveyance 110 such that once that limit is exceeded; further pull on conveyance 110 may be prevented.

In examples, borehole sonic logging tool 102 may operate with additional equipment (not illustrated) on surface 108 and/or disposed in a separate borehole sonic logging system (not illustrated) to record measurements and/or values from formation 132. Borehole sonic logging tool 102 may comprise a transmitter 128. Transmitter 128 may be connected to information handling system 114, which may further control the operation of transmitter 128. Transmitter 128 may include any suitable transmitter for generating sound waves that travel into formation 132, including, but not limited to, piezoelectric transmitters. Transmitter 128 may be a monopole source or a multi-pole source (e.g., a dipole source). Combinations of different types of transmitters may also be used. During operations, transmitter 128 may broadcast sound waves from borehole sonic logging tool 102 that travel into formation 132. The sound waves may be emitted at any suitable frequency range. For example, a broad band response could be from about 0.2 KHz to about 20 KHz, and a narrow band response could be from about 1 KHz to about 6 KHz. It should be understood that the present technique should not be limited to these frequency ranges. Rather, the sounds waves may be emitted at any suitable frequency for a particular application.

Borehole sonic logging tool 102 may also include a receiver 130. As illustrated, there may be a plurality of receivers 130 disposed on borehole sonic logging tool 102. Receiver 130 may include any suitable receiver for receiving sound waves, including, but not limited to, piezoelectric receivers. For example, the receiver 130 may be a monopole receiver or multi-pole receiver (e.g., a dipole receiver). In examples, a monopole receiver 130 may be used to record compressional-wave (P-wave) signals, while the multi-pole receiver 130 may be used to record shear-wave (S-wave) signals. Receiver 130 may measure and/or record sound waves broadcast from transmitter 128 as received signals. The sound waves received at receiver 130 may include both direct waves that traveled along the borehole 124 and refract through formation 132 as well as waves that traveled through formation 132 and reflect off near borehole bedding and propagate back to the borehole. The reflected waves may include, but are not limited to, compressional (P) waves and shear(S) waves. By way of example, the received signal may be recorded as an acoustic amplitude as a function of time. Information handling system 114 may control the operation of receiver 130. The measured sound waves may be transferred to information handling system 114 for further processing. In examples, there may be any suitable number of transmitters 128 and/or receivers 130, which may be controlled by information handling system 114. Information and/or measurements may be processed further by information handling system 114 to determine properties of borehole 124, fluids, and/or formation 132. By way of example, the sound waves may be processed to generate a reflection image of formation structures, which may be used for dip analysis as discussed in more detail below.

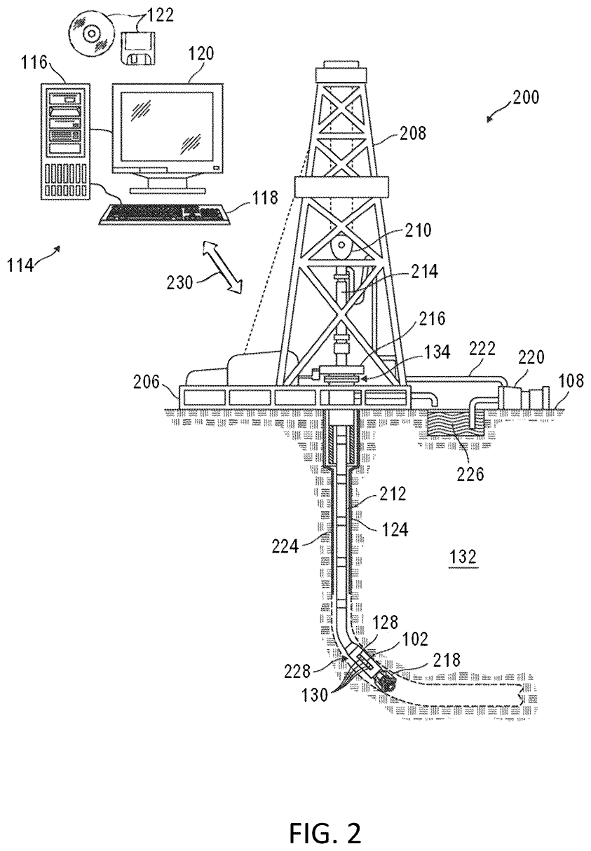

FIG. 2 illustrates an example in which borehole sonic logging tool 102 may be included in a drilling system 200. As illustrated, borehole 124 may extend from wellhead 134 into formation 132 from surface 108. A drilling platform 206 may support a derrick 208 having a traveling block 210 for raising and lowering drill string 212. Drill string 212 may include, but is not limited to, drill pipe and coiled tubing, as generally known to those skilled in the art. A Kelly drive 214 may support drill string 212 as it may be lowered through a rotary table 216. A drill bit 218 may be attached to the distal end of drill string 212 and may be driven either by a downhole motor and/or via rotation of drill string 212 from surface 108. Without limitation, drill bit 218 may include, roller cone bits, PDC bits, natural diamond bits, any hole openers, reamers, coring bits, and the like. As drill bit 218 rotates, it may create and extend borehole 124 that penetrates various subterranean formations 204. A pump 220 may circulate drilling fluid through a feed pipe 222 to kelly 214, downhole through interior of drill string 212, through orifices in drill bit 218, back to surface 108 via annulus 224 surrounding drill string 212, and into a retention pit 226.

With continued reference to FIG. 2, drill string 212 may begin at wellhead 134 and may traverse borehole 124. Drill bit 218 may be attached to a distal end of drill string 212 and may be driven, for example, either by a downhole motor and/or via rotation of drill string 212 from surface 108. Drill bit 218 may be a part of bottom hole assembly 228 at distal end of drill string 212. Bottom hole assembly 228 may further comprise borehole sonic logging tool 102. Borehole sonic logging tool 102 may be disposed on the outside and/or within bottom hole assembly 228. Borehole sonic logging tool 102 may comprise a plurality of transmitters 128 and/or receivers 130. Borehole sonic logging tool 102 and/or the plurality of transmitters 128 and receivers 130 may operate and/or function as described above. As will be appreciated by those of ordinary skill in the art, bottom hole assembly 228 may be a measurement-while drilling (MWD) and/or logging-while-drilling (LWD) system.

Without limitation, bottom hole assembly 228, transmitter 128, and/or receiver 130 may be connected to and/or controlled by information handling system 114, which may be disposed on surface 108. Without limitation, information handling system 114 may be disposed down hole in bottom hole assembly 228. Processing of information recorded may occur down hole and/or on surface 108. Processing occurring downhole may be transmitted to sur-face 108 to be recorded, observed, and/or further analyzed.

Additionally, information recorded on information handling system 114 that may be disposed down hole may be stored until bottom hole assembly 228 may be brought to surface 108. In examples, information handling system 114 may communicate with bottom hole assembly 228 through a communication line (not illustrated) disposed in (or on) drill string 212. In examples, wireless communication may be used to transmit information back and forth between information handling system 114 and bottom hole assembly 228. Information handling system 114 may transmit information to bottom hole assembly 228 and may receive, as well as process, information recorded by bottom hole assembly 228. In examples, a downhole information handling system (not illustrated) may include, without limitation, a microprocessor or other suitable circuitry, for estimating, receiving and processing signals from bottom hole assembly 228. Down-hole information handling system (not illustrated) may further include additional components, such as memory, input/output devices, interfaces, and the like. In examples, while not illustrated, bottom hole assembly 228 may include one or more additional components, such as analog-to-digital converter, filter and amplifier, among others, that may be used to process the measurements of bottom hole assembly 228 before they may be transmitted to surface 108. Alternatively, raw measurements from bottom hole assembly 228 may be transmitted to surface 108.

Any suitable technique may be used for transmitting signals from bottom hole assembly 228 to surface 108, including, but not limited to, wired pipe telemetry, mud-pulse telemetry, acoustic telemetry, and electromagnetic telemetry. While not illustrated, bottom hole assembly 228 may include a telemetry subassembly that may transmit telemetry data to surface 108. Without limitation, an electromagnetic source in the telemetry subassembly may be operable to generate pressure pulses in the drilling fluid that propagate along the fluid stream to surface 108. At surface 108, pressure transducers (not shown) may convert the pressure signal into electrical signals for a digitizer (not illustrated). The digitizer may supply a digital form of the telemetry signals to information handling system 114 via a communication link 230, which may be a wired or wireless link. Telemetry data may be analyzed and processed by information handling system 114.

As illustrated, communication link 230 (which may be wired or wireless, for example) may be provided which may transmit data from bottom hole assembly 228 to an information handling system 114 at surface 108. Information handling system 114 may include a processing unit 116, a video display 120, an input device 118 (e.g., keyboard, mouse, etc.), and/or non-transitory computer-readable media 122 (e.g., optical disks, magnetic disks) that may store code representative of the methods described herein. In addition to, or in place of processing at surface 108, processing may occur downhole.

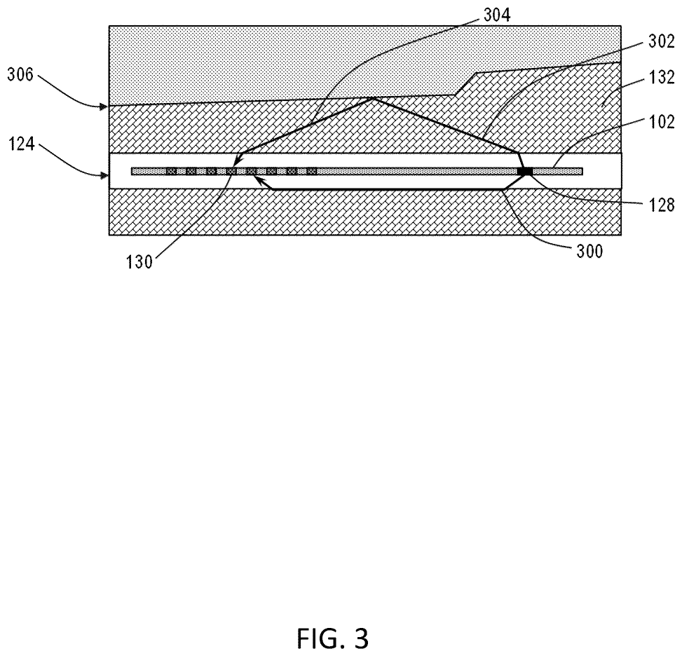

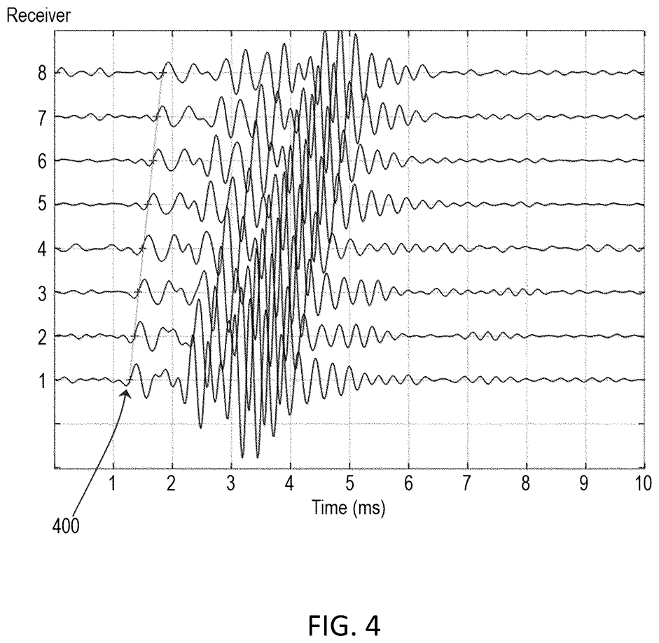

FIG. 3 illustrates a full-waveform sonic tool 102 located in borehole 124 near a high-angle structure of interest away from the borehole. Sonic source 128 is fired and then standard processing uses data received on receivers 130 to identify guided modes 300 along the well and their velocity. In addition, body wave compressional or shear waves 302 may be generated by the borehole sonic source drive with the result that secondary arrivals 304 reflected off structural boundary 306 away from the borehole 124 may be present and it is those secondary arrivals that can be used to image away from the borehole. Here it should be noted that the borehole sonic source drive and receivers can be monopole or multipole (e.g. dipole) and the signals generated either compressional or shear waves.

FIG. 4 illustrates raw full-waveform sonic data measured with a borehole sonic logging tool 102 that includes eight receivers 130. The first detectable arrivals 400 for the data may be the flexural waves of borehole 124 that are used to measure the shear slowness of the near-borehole formation 132 along the axis of borehole 124. In addition to this borehole mode, true formation body shear 302 may be excited by transmitters 128 and will radiate away from borehole 124. In examples, the flexural waves may be further processed to estimate S-wave slowness. Some monopole components may be present as well that can have application. For example, P-wave data may be used for reflection imaging, however, the focus with this source firing and receiver configuration may be the dipole generated signals that include the borehole flexural wave and shear waves radiated away from the borehole.

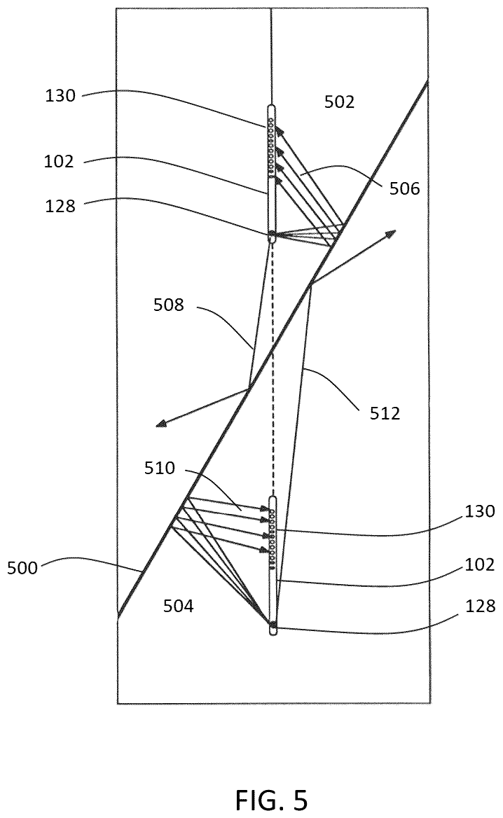

FIG. 5 illustrates a full-waveform sonic tool 102 at two positions in the borehole. For this example, we assume the borehole sonic tool is pulled up the well to acquire full-waveform sonic data and so for this example data are first acquired at position 504 and then acquired at position 502. At the lower position 504 arrivals propagate out from source 128 to dipping bed 500 and then downgoing arrivals 510 are reflected to receivers 130. With this geometry it is apparent that the signals reflect down to the receivers 130 and so the signals required to best image the downwardly dipping structure will be propagating in a downward direction along the array of receivers 130. At the second position in the well 502, the opposite is seen and upgoing arrivals 506 reflect from dipping bed 500 to receivers 130 and so the signals required to best image the upwardly dipping structure will be propagating in an upward direction along the array of receivers 130. For the case of dipping beds crossing the well it may be desired to separately image the upwardly and downwardly dipping formations crossing the well so that the highest quality image can be achieved in each case and the two images can be combined to visualize the dipping bed boundaries crossing the well. As is known by those of ordinary skill in the art the imaging of either upwardly or downwardly dipping structure is best done with the data targeted for either geometry and all other arrivals in the wave train can be essentially treated as noise. The result is that the best imaging can be achieved by rejection of these other arrivals as much as possible. Pre-treatment of the data can help with this process, for example one may use a frequency-wavenumber (FK) filter to separate up and downwardly propagating signals across the array. Imaging would then proceed by performing the pre-stack depth migration process individually using the upwardly propagating signals along with a velocity model configured for upwardly dipping structure and using the downwardly propagating signals along with a velocity model configured for downwardly dipping structure.

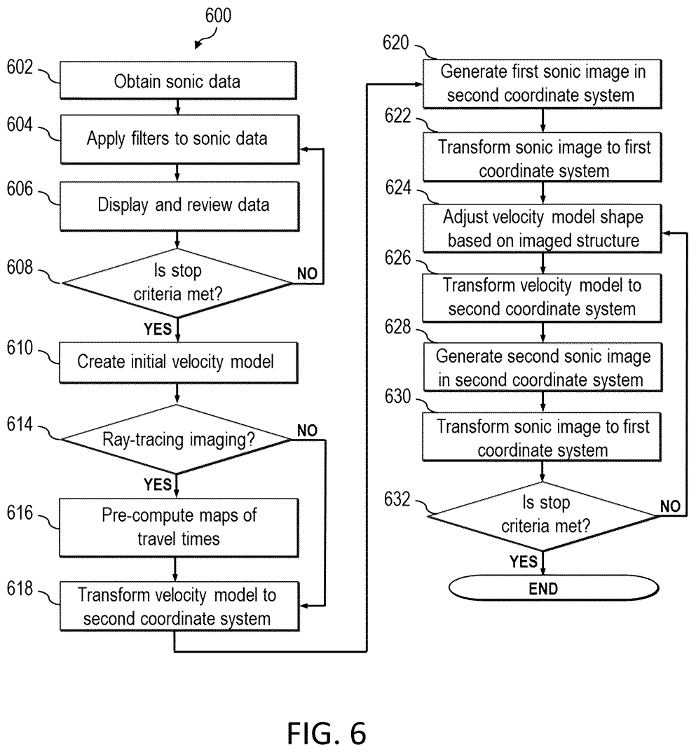

FIG. 6 illustrates a workflow for reflection sonic imaging. Workflow 600 may depict a method to create a high-quality reflection sonic image of bedding or other structure of interest away from the borehole 124. Flowchart 600 may comprise multiple steps to create the reflection borehole sonic image. Workflow 600 may begin with step 602 in which full-waveform sonic data are acquired using tool 102 (e.g., referring to FIG. 3). The full-waveform sonic data may be obtained using any suitable technique. As previously described, the full-waveform sonic data may be obtained by firing one or more transmitters 128 to generate sound waves. One or more receivers 130 may be used to receive sound waves, for example, by measuring one or more properties of at least a portion of the sound waves. By way of example, the receivers 130 may measure velocity, amplitude, amplitude attenuation, and frequency. The sound waves may include both direct waves 300 that travel along borehole 124 as well as waves that travel through formation 132, including, but not limited to, shear(S) waves, compressional (P) waves, and Stoneley waves. Some of the sound waves emitted from transmitters 128 may not be received at receivers 130. The sonic data may include any suitable sonic data for generating a formation image for dip analysis. Suitable data may include full-waveform data and the corresponding velocity logs. The term “full waveform” data may be defined as data recorded at each receiver of the signal response of the waves impacting the receiver, as a function of time (FIG. 4). The data may include P-wave data, S-wave data, or both P-wave data and S-wave data.

In step 604 the recorded data (for example using dipole shear sonic data) may be prepared for imaging by one or more methods. Step 604 may include steps such as de-noising to remove spurious data, band-pass filtering, separation of reflected signals from direct signals, and separation of up and downgoing arrivals to use to image bedding crossing the borehole.

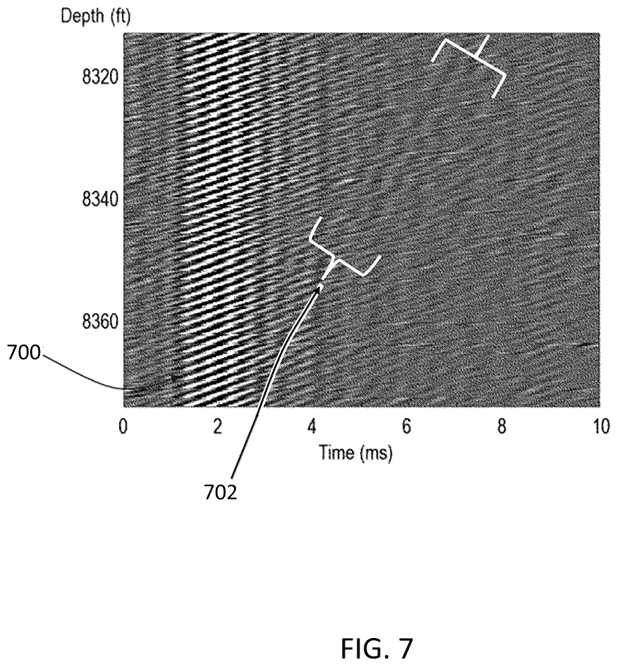

FIG. 7 shows one example of a display of processed full-waveform sonic data from step 604 to visualize the signals reflected off near-borehole structure in the time domain step 608. For this display the signals are body wave shear signals excited by a dipole source and received by an array of receivers. FIG. 7 displays integrated data for received signals for a number of borehole positions of the sonic tool. Guided wave arrivals 700 reveal the slope of the directly arriving waveforms across the array for each tool position. Reflected sonic signals 702 are now revealed at later times and the apparent moveout of these arrivals are seen to be dependent on the relative angle of the structure away from the well, with structure that is more parallel to the well giving a more vertical moveout in time (e.g., FIG. 3).

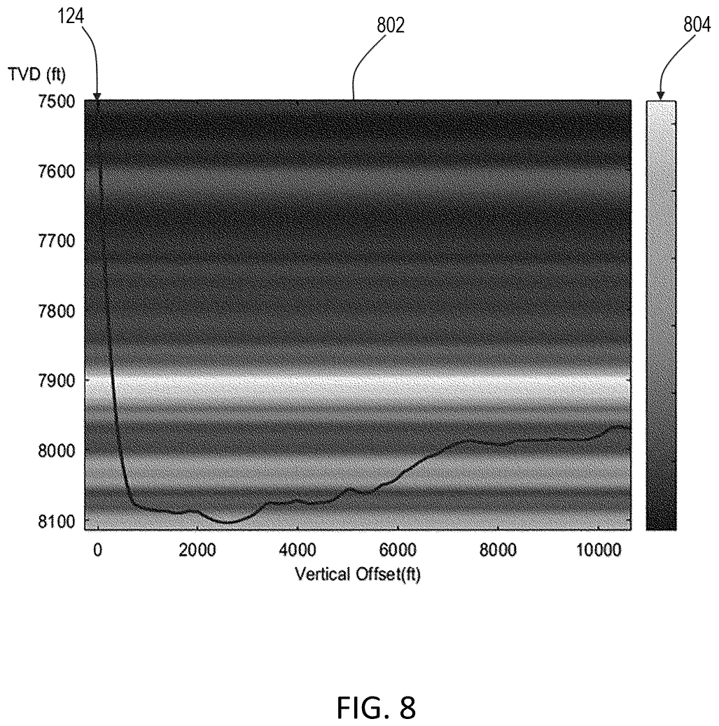

Returning to FIG. 6, after the sonic imaging practitioner is satisfied with the data preparation step 604 as displayed in step 606 the 608 stop criteria may be met and the workflow moves to step 610. FIG. 8 shows a plot of borehole 124 in True Vertical Depth (TVD) and Vertical Offset (VO) coordinates superimposed on a 2-dimensional view of a shear-wave velocity map 802 for the region of the earth encountered by the well and away from the well. These coordinates are supplied by drilling engineers and this 2-dimensional view is oriented, in earth coordinates, along the direction the well is drilled. This coordinate system in True Vertical depth and Vertical Offset will be referred to as the first coordinate system going forward.

Borehole 124 in FIG. 8 is an extended-reach horizontal well that starts out near vertical and then slowly increases deviation angle until the well transitions to a near-horizontal angle around VO 600 to 1000. With FIG. 8 it is noted that the vertical axis is greatly exaggerated with 600 ft TVD change on the vertical axis and more than 10000 ft change on the horizontal axis. This shear wave velocity map 802 is core to this invention and may be constructed by taking a shear velocity log derived from sonic data recorded along the borehole in the well of interest and smoothing that velocity to create a smoothed velocity log as a function of depth along the borehole. In this case the sonic source 128 is a dipole source and the sonic tool is configured to record guided waves at receivers 130 that are then used to compute the shear wave velocity along the borehole (e.g. FIG. 2). The smoothing of the velocity data for imaging purposes can be accomplished by any means available to the sonic imaging practitioner, for example using a running median filter to reduce noise spikes, coupled with a running median average to create the final smoothed velocity log. In addition to the data recorded in the well of interest, velocity data from offset wells to the well of interest can be used in the creation of the 2-dimensional velocity map. The 2-dimensional velocity model 802 is then created by extrapolating the smoothed shear velocity data from 1 or more wells along geological dip directions along the section of earth penetrated by the borehole. Geological dip can be estimated, or input measured by the well log data as recorded from a dipmeter or borehole wall imaging device, for example. In this case for construction of the starting velocity model the bedding is assumed to be horizontal in line with expected geology for this field and average measurements of bedding dip in the well of interest. 804 gives the scale of the velocity in the model, with the darkest shade the lowest velocity and the lightest shade the highest velocity.

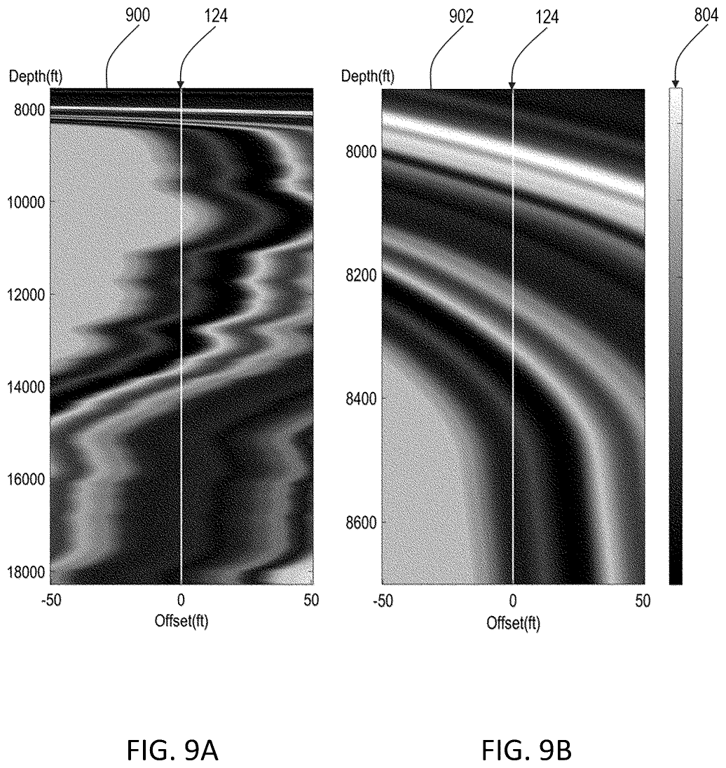

Returning to FIG. 6, in step 610 this initial velocity model 802 in the first coordinate system is transformed to a velocity model 900 in a second coordinate system, as shown in FIG. 9A. This second coordinate system is set up relative to a borehole fixed axis 124. Note that for every TVD-VO data point shown for well 124 in FIG. 8 we also have the measured depth for each measurement point along the borehole that is not displayed on the first coordinate system that is in FIG. 8. This transformation essentially takes the borehole position in FIG. 8 in TVD and VO and extracts the velocity map along each position orthogonal to the borehole for each depth position along the borehole. This transformation to a second coordinate system greatly facilitates the reflection imaging processing as all data, travel time tables, velocity map and imaging map are now referenced to a linear and fixed borehole depth axis.

FIG. 9A shows the velocity map 900 relative to a linear depth reference axis of the borehole 124 with the velocity map plotted to the distance on each side of the well that denotes the maximum reflection imaging distance away from the well desired or possible with the recorded full-waveform sonic data. For example, the data may be recorded for a length of time that allows imaging to a distance away from the well of up to 50 ft, as is the case for our example data set. FIG. 9B shows a subset 902 of the full velocity model 900 relative to borehole 124 as it passes through the upper interval where the borehole transforms from intersecting beds penetrated by the borehole to a near-horizontal trajectory where the bedding is located some distance from the well and does not intersect the well at all for thousands of feet. For velocity model 902 it is clear for the interval where the bedding crosses the well the angle of the bedding changes as it progresses away from the well. First—the bedding angle as the beds go away from the well is not fixed and in fact can be seen to be curved in shape away from the well for this interval from the top depth down to when the well goes horizontal around 8400 ft. Second—the shape and angle of the bedding is different from one side of the well to the other. And so, what is clear in this case using the bedding dip as measured at the borehole wall is not the best method to estimate the velocity model away from the well. Further it is noted on FIG. 9B that in the near-horizontal section below 8400 ft the beds away from the well along with their velocity cannot be predicted by borehole log measurements. In this case the first velocity model is estimated as previously noted and imaging results are then used to update the velocity model itself. Final reflection mapping away from the well and determination of accurate placement of the reservoir boundaries away from the well will come from iterative imaging and velocity model update.

Returning to FIG. 6, step 614 is a decision based on the imaging code planned to be deployed for the reflection sonic imaging. If the code is a pre-stack ray tracing solution such as Kirchhoff or Generalized Radon Transform migration then the next step is 616 where pre-computed travel time maps are computed, otherwise if the pre-stack imaging code is not ray tracing based, such as Reverse-Time Migration imaging then step 616 is skipped. The preferred embodiment of this invention is focused on a pre-stack depth migration ray tracing solution such as Kirchhoff or Generalized Radon Transform migration.

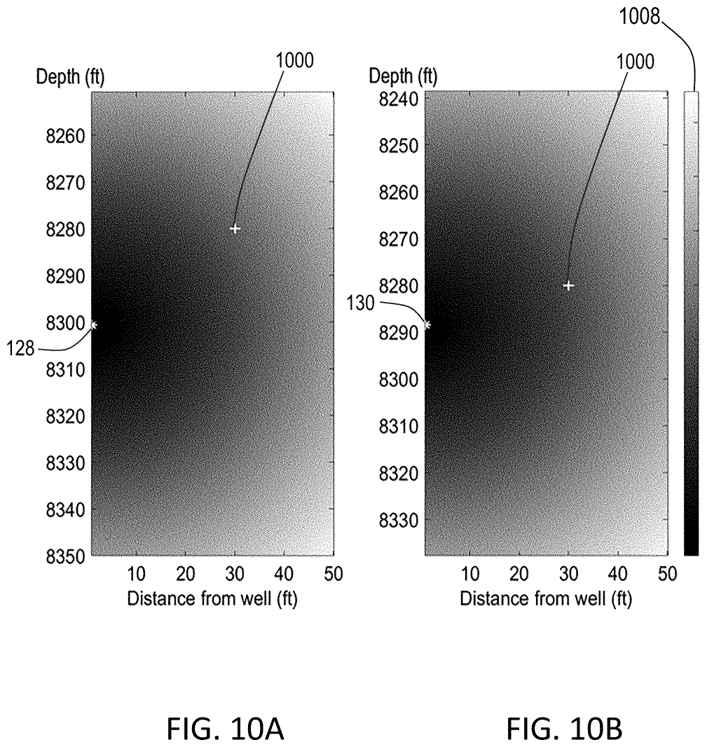

For the next step 616 for ray tracing based pre-stack depth imaging FIGS. 10A and 10B show examples of pre-computation of travel time tables. FIG. 10A depicts a travel time table for sonic waves propagating from a source 128 located at a position in the borehole indicated by the asterisk to points in the vicinity of the borehole. This travel-time table contain hundreds of points representing estimated travel times for acoustic signals (shear wave signals for this case) filling a fine grid of imaging points away from the well for a 100 ft section of the borehole axis to 50 ft from the borehole. Highlighted by a cross is a single point 1000 located at 8300 borehole depth and 30 ft from the well. Similarly, FIG. 10B depicts a travel time table for sonic wave propagating from points in the vicinity of the borehole, such as point 1000, to a receiver 130 indicated by the asterisk. In both FIGS. 10A and 10B the travel time at each point in the travel time table is indicated by the grayscale 1008. And so, for zero-time the point is black and for maximum time, here around 9 milliseconds, the point is white with a range of variations between the times 0 to 9 milliseconds. The travel time tables displayed in FIGS. 10A and 10B are each calculated on a fine scale grid. Here by “fine scale” we mean a travel time grid that is fine enough that travel times can be accurately obtained for depth imaging. In the example shown, the travel time grid is populated with a grid of 0.25 ft which has been found to be more than fine enough to achieve optimal imaging results with any frequency and wavelength of full-waveform sonic data. In like manner—this fine spacing is also used for each depth change used for one travel time grid reference depth to the next depth. And finally, the output imaging grid resolution for the final imaging result is also based on the same fine scale, in this case the same spacing of 0.25 ft. A further constraint is that this spacing should be shorter than the depth changes between adjacent borehole sonic depth positions. This depth change between adjacent borehole sonic depth position is normally 0.5 ft, and so the chosen 0.25 ft spacing for travel time tables sand and imaging grid will work. If, for example, a very high-frequency special borehole sonic acquisition is recorded at 0.25 ft spacing along the borehole then the borehole sonic imaging practitioner can elect to decrease spacing for travel time tables and imaging grid to a finer scale of 0.125 ft, for example. The depth sampling of data and the spacing for travel time tables are of course not limited by these values. These pre-computed tables are used to quickly look up arrival times from recorded sonic data that are then used to guide the imaging of these data. Essentially for ray-based pre-stack depth migration these travel time tables are created using the velocity model to provide times to fixed points in the imaging space away from the borehole for all sonic source and receiver positions along the borehole.

In FIG. 10A the source location 128 is indicated by the asterisk which is around 8300 ft along the borehole and at zero-time and 1000 points to a single imaging point away from the well which is approximately 30 feet from the borehole and at approximately 4 milliseconds time. Likewise for FIG. 10B, which uses a different travel time table to target a single receiver located on the tool at a depth position that is shallower by the source to receiver spacing. And so, receiver 130 points to the receiver location along the borehole which is just above 8290 ft and at zero time. And in a similar fashion, 1002 points to the same imaging point of interest 1002 targeted by FIG. 10A and shows the time from imaging point 1000 to the single receiver 130. Addition of these 2 travel times gives the time from source to imaging point and back to a single receiver. For imaging this travel time determines a single waveform sample at that time which is then summed into the imaging point of interest. For example, referring to FIG. 4, for receiver 1, if the summed times are 8 ms, say, for the single imaging point location then the waveform sample at that time is summed into the image matrix point at that location. The process is then repeated for all source and receiver positions in the well and for all imaging points away from the well. Weighting factors may be used by the imaging algorithm to modify the waveform amplitude before stacking that compensates for attenuation and geometrical effects, for example.

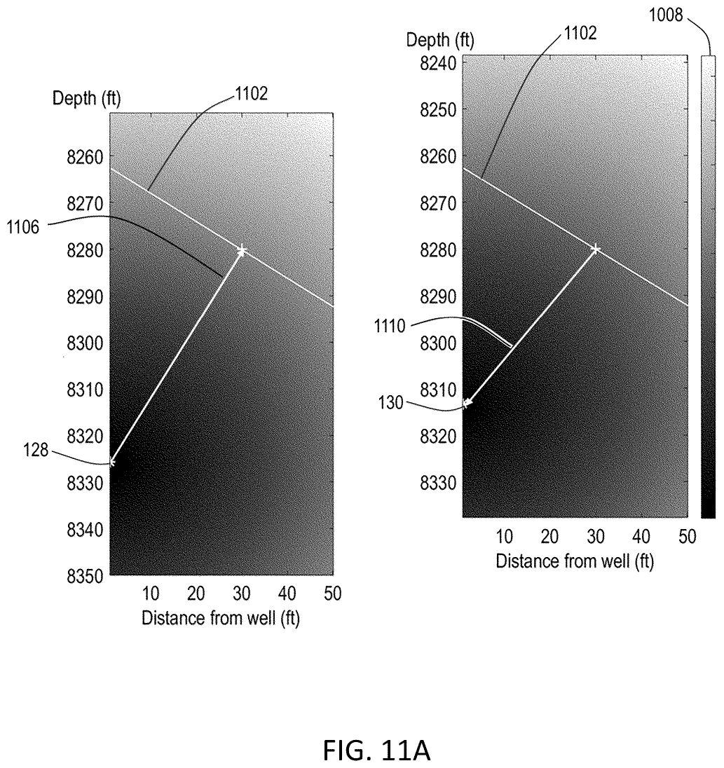

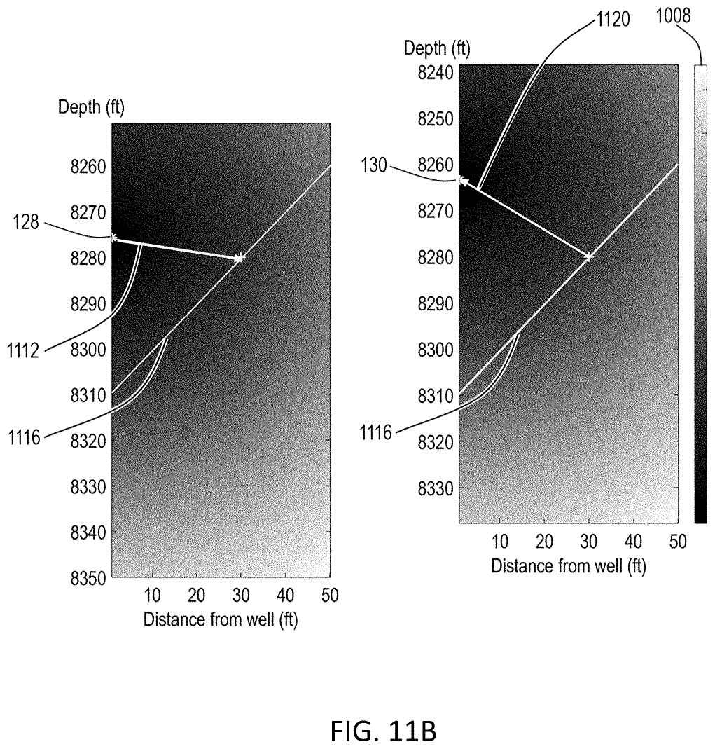

FIG. 11 shows a different way of pre-computing the travel times, in accordance with one or more embodiments. Here the zero-time position on the travel time table is changed to either a low (FIG. 11A) or a high point on the travel time table (FIG. 11B). In the description of FIGS. 11A and 11B the terms “high point”, “low point”, “upwardly traveling”, and “downwardly traveling”, etc., are used. These terms are intended to refer to positions and directions along the borehole. For example, downwardly traveling implies traveling in a direction of increasing distance along the borehole, or in a with a positive vector component of propagation in the direction of increasing depth. In contrast upwardly traveling implies traveling in a direction of decreasing distance along in the borehole, or in a with a negative vector component of propagation in the direction of increasing distance along the borehole. In many cases such a downwardly traveling wave will be traveling in a direction of increasing depth below the surface, but in cases where the borehole is horizontal or even moving closer to the surface of the earth with increasing distance along the borehole the reverse may be true.

Referring to FIG. 11A, the low location 128 of the source at the zero-time position (FIG. 11A) will naturally select the downgoing sonic arrivals 1110 reflected from example downwardly dipping structure 1102 and propagating back to receiver 130. Here the left panel of FIG. 11A represents the travel time table for the source 128 to a single image point at depth 8280 and 30 ft from the borehole. 1106 is an approximate, straight line, ray path depicting the travel of the sonic signal from the source 128 to the single image point. The right side of FIG. 11A displays the travel time table for a single receiver 130 and shows the approximate ray-path 1110 that goes from the single image point to a single receiver 130 located in the borehole. Now with the low position selected for the placement of the zero-time (source) position 128 on the travel time table, it is apparent that most of the candidate image points as represented for the source 128 are above the source and so signals will be predominately reflected in a downward direction and target mostly downwardly dipping structure with the imaging process. And so, with the predominately upwardly traveling signal from the source 128 to the image points and the predominately downward traveling signal from the image point to the receivers 130 then it can be seen that the placement of the zero-time position on the low side of the travel time tables will serve to target primarily the downwardly traveling sonic signals which, referring to FIG. 5, will produce images primarily of the downwardly dipping structure.

Referring to FIG. 11B, the high location 128 of the source at the zero-time position (FIG. 11B) will naturally select the upgoing sonic arrivals 1120 reflected from example upwardly dipping structure 1116 and propagating back to receiver 130. Here the left panel of FIG. 11B represents the travel time table for the source 128 to a single image point at depth 8280 and 30 ft from the borehole. 1112 is an approximate, straight line, ray path depicting the travel of the sonic signal from the source 128 to the single image point. The right side of FIG. 11B displays the travel time table for a single receiver 130 and shows the approximate ray-path 1120 that goes from the single image point to a single receiver 130 located in the borehole. Now with the high position selected for the placement of the zero-time (source) position 128 on the travel time table, it is apparent that most of the candidate image points as represented for the source 128 are below the source and so signals will be predominately reflected in a upward direction and target mostly upwardly dipping structure with the imaging process. And so with the predominately downwardly traveling signal from the source 128 to the image points and the predominately upwardly traveling signal from the image point to the receivers 130 then it can be seen that the placement of the zero-time position on the high side of the travel time tables will serve to target primarily the upwardly traveling sonic signals which, referring to FIG. 5, will produce images primarily of the upwardly dipping structure.

FIGS. 11A and 11B show travel time tables for one source and receiver position, it is noted that for a single source position 128 all receivers 130 deployed by sonic tool 102 will have a separate travel time table with the zero-time point at the receiver depth.

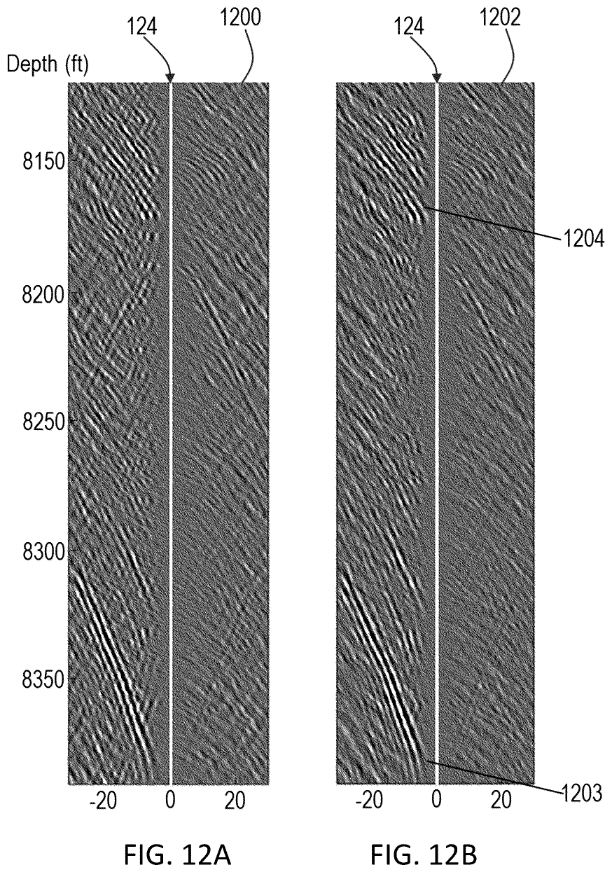

Sonic imaging results are computed in step 616 and FIG. 12A shows the result of sonic imaging 1200 using shear full-waveform sonic data that had the up and downgoing arrivals separated in step 604 (FIG. 6) and travel time tables that have the zero-time point in the vertical center and horizontal left edge as, for example 1000 in FIG. 10A. In a similar fashion, FIG. 12B shows the sonic imaging results 1202 over the same borehole interval processed for FIG. 12A with no pre-processing of the full-waveform sonic data to separate up and downgoing arrivals and using the travel time tables configured for downwardly dipping structure (FIG. 11A) and for upwardly dipping structure (FIG. 11B). For both FIGS. 12A and FIG. 12B the imaging results on the left side of borehole 124 target the upwardly dipping structure and the imaging results on the right side of borehole 124 target the downwardly dipping structure. Combining the two sonic imaging results gives a view of the bedding crossing the borehole from downward dipping on the right side to upwardly dipping on the left side. In this section we have borehole wall imaging results for comparison, and we see that the resulting relative angle of the imaged bedding 1203 of 78 degrees at ˜8380 ft depth and the resulting relative angle of the imaged bedding 1204 of 61 degrees at ˜8160 ft depth matches the known relative angle of the bedding at those depth locations. Comparing the resulting sonic images for FIG. 12A and FIG. 12B we see that a good and comparable result was obtained using the two different procedures.

An advantage to note of using the travel time tables configured for upwardly and downwardly dipping structures instead of pre-processing the data to separate up and downgoing arrivals is that there is no dependance on obtaining good quality up and downgoing arrival separation. If the borehole sonic array data is compromised for example by having 1 or more receivers not functional, then the up and downgoing separation can be compromised. In addition, if the borehole sonic tool has simply a single source and a single receiver then it is not possible to separate up and downgoing arrivals as this process needs an array of receivers. However, the method to use the travel time tables configured for upwardly and downwardly dipping structures operates on a receiver by receiver basis and so this method may work equally well for the case of a single receiver sonic tool as for a multiple receiver sonic tool.

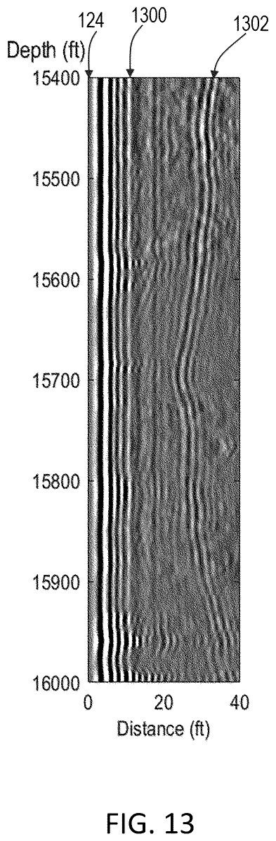

For this sort of extended-reach horizontal well the main focus of interest is imaging in the horizontal section of the well to identify reservoir boundaries away from the well to aid completion engineer's choice of where to frack the well. FIG. 13 shows sonic image results for a section of the horizontal well relative to the borehole in the second coordinate system. In this case of a horizontal well targeting near-horizontal formation boundaries away from the borehole there is essentially no dipping structure crossing the well and the imaging is simplified to using all data to directly imaging away from the well, much in the same way a surface seismic ocean towed streamer array targets subsurface geology located below the ocean. Data for this section was simply processed in step 604, FIG. 6, using a band-pass filter to cut out high-frequency noise. Note that the near borehole imaging results 1300 that follow the same line as the borehole 124 are simply a result of direct arrivals not removed from the data prior to imaging. Sonic imaging result 1302 is clearly identified in FIG. 13 as this sonic image does not exactly follow the borehole. The sonic image 1302 details the location of a key formation boundary changing from around 20 ft from the borehole to around 40 ft from the borehole during the section imaged.

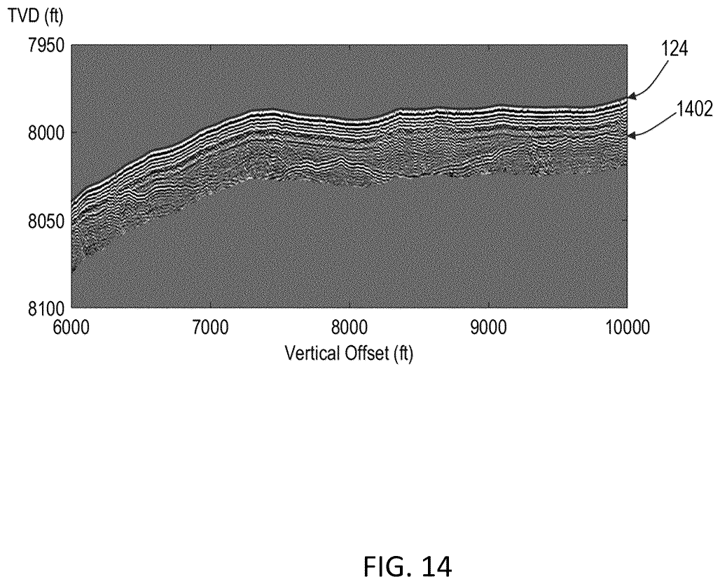

Next FIG. 14 shows a plot of the sonic imaging results displayed in the first coordinate system for the main section of interest along the horizontal well section, from 6000 to 10000 ft Vertical Offset. 124 points to the borehole which follows the upper edge of the image. 1402 points to the main reservoir boundary of interest away from the well. As can be seen this boundary image reaches a maximum distance from borehole 124 at ˜50 ft and comes to intersect borehole 124 around 6000 ft Vertical Offset. Note the vertical TVD dimension of 150 ft is greatly exaggerated relative to the horizontal Vertical Offset of 4000 ft. Here practical information of value to a drilling engineer is the high-resolution imaging of the bed boundaries 1402 relative to borehole 124.

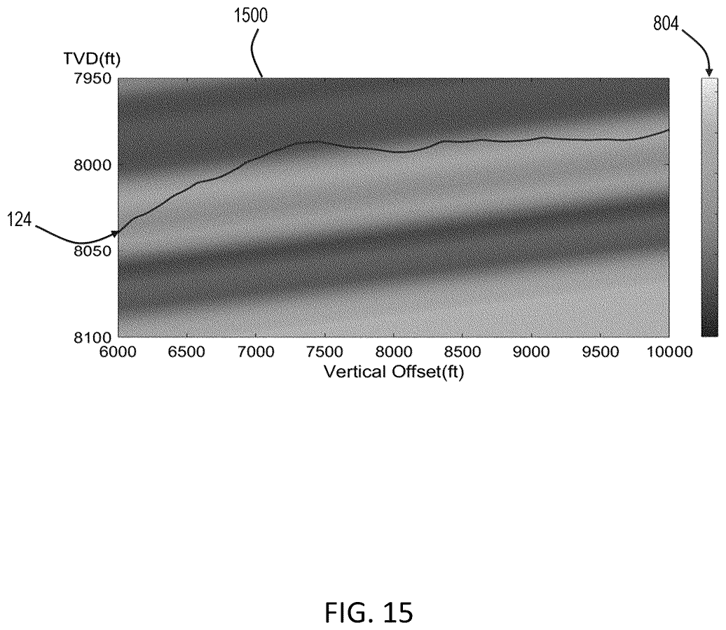

For step 622 in FIG. 6 FIG. 15 illustrates an adjusting of the velocity model based on a simple straight line fit to the imaged section as seen in FIG. 14. Here the modified velocity model 1500 may be accomplished by any number of methods without limitation. For example, the modified velocity model can be arrived at by contouring the velocity model along a bed boundary or boundaries of interest, for example. This contouring could be facilitated, for example, by applying a graphical user interface (GUI) where the sonic imaging practitioner picks a number of points along the reservoir boundary of interest and then fits a curved line on these points that generally follows the reservoir boundary of interest. This curved line is then used to adjust the velocity model boundary equivalent to the structural boundary of interest as revealed by the sonic imaging results. The method to modify the velocity model can also be based on a purely automatic processing method, for example.

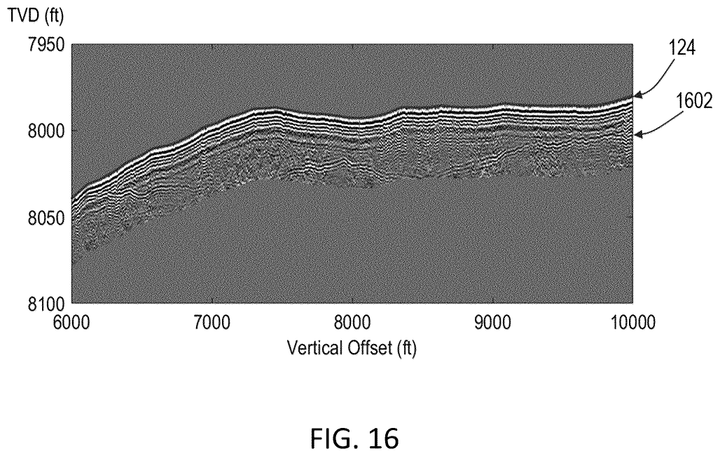

FIG. 16 shows the resulting reflection imaging result 1602 after using the modified velocity model with steps 626 and 630 (FIG. 6). Note that little change in the image is seen by this result, and so at this stage no further modifications are required.

An additional benefit of the sonic imaging workflow that results in the updated velocity model and final sonic image is that the same process can be used to visualize formation properties away from the borehole at high resolution and so create a high-resolution earth model of the desired parameter. For example, a high-resolution earth model of Geomechanics properties may be determined from the sonic image, the updated velocity model, and well logs of one or more formation property. An example is to estimate a model of the Geomechanics parameter Young's modulus away from the borehole.

Young's modulus can be estimated from borehole log data is as follows:

$$E = {ρβ}^{2} ( \frac{3 {∝}^{2} - 4 {β}^{2}}{{∝}^{2} - {β}^{2}} )$$

where E is Young's Modulus (Pascals); ∝ is P-wave velocity (m/s); β is S-wave velocity (m/s) and ρ is bulk density (kg/m3).

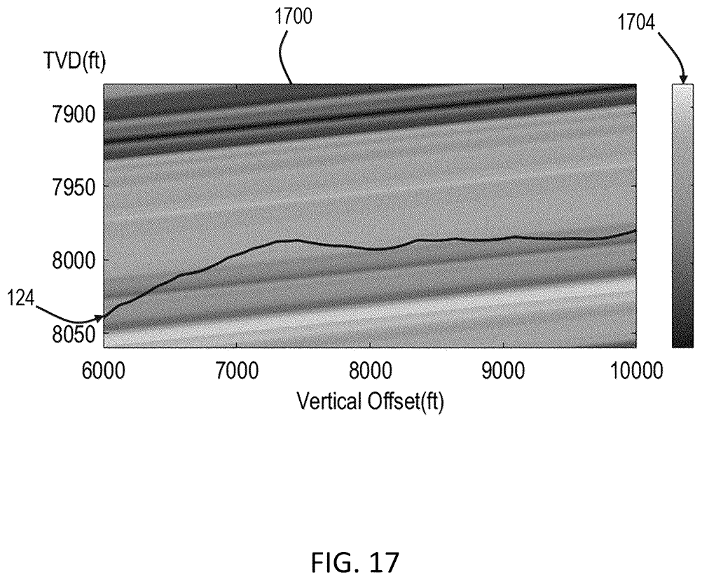

FIG. 17 shows a high-resolution earth model 1700 of Young's modulus in the first coordinate system and created using the workflow used to create the final velocity model for imaging as well as compressional and shear wave velocity and formation density log data using the above calculation. The position of borehole 124 is overlaid on the high-resolution earth model. Data for this Geomechanics model is obtained in the same way and from the same sources as used for the data used to populate the 2D velocity model created for the reflection sonic imaging. This illustrates a simple visualization away from the borehole of one Geomechanics property, Young's modulus in the final determined structure away from the borehole. In FIG. 17 the value for Young's modulus each point in the model is indicated by the grayscale 1704. And so, at the minimum value for Young's modulus the point is black and has a value of 0.1 Pascals and for the maximum value, here around 0.27 Pascals, the point is white with a range of variations between these values. This property can be used by engineers as an input for their well completion plan for fracking the well, for example.

Note the same steps can be applied to other high-resolution borehole logs to create other, complex, high-resolution earth model visualizations of these formation properties along with derived Petrophysical and Geomechanical properties, for example, to further aid Petrophysicists and completion engineers to target intervals for well completion and fracking or to help define intervals for offset drilling to aid field development, for example.

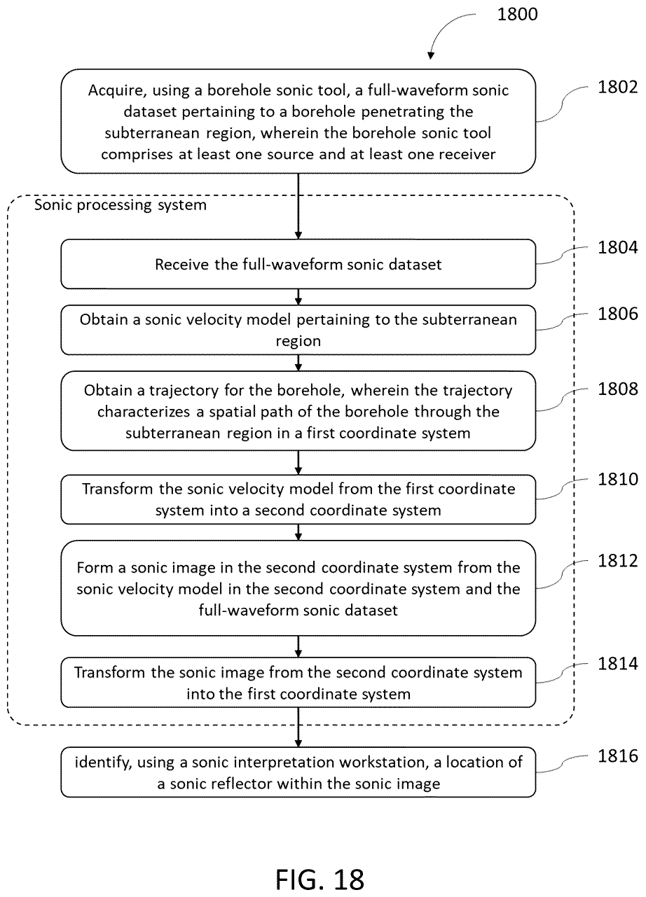

FIG. 18 depicts a flowchart 1800 in accordance with one or more embodiments. Flowchart 1800 commences with Step 1802 in which a full-waveform sonic dataset pertaining to a borehole penetrating the subterranean region, is acquired using a borehole sonic tool. The borehole sonic tool includes at least one source and at least one receiver. The borehole may be in parts vertical, highly deviated, and/or horizontal. Further the borehole may include straight portions and curved portions. While the borehole may in general descend to greater depths below the surface with increasing length along the borehole, in some cases a portion of the borehole may ascend to shallower depths with increasing length along the borehole.

In Step 1804 the full-waveform sonic dataset may be received from the borehole sonic tool by a sonic processing system. The sonic processing system may include a computer system including one or more computer processing units, network storage devices, such as random-access memory (RAM), one or more processing resources such as a central processing unit (CPU) or hardware or software control logic, ROM, and/or other types of nonvolatile memory. Additional components may include one or more disk drives, hard drives, one or more network ports for communication with external devices as well as various input and output (I/O) devices. Input devices may include keyboard, mouse, etc.) and output devices may include computer screens and video displays. The sonic processing system may also include one or more buses operable to transmit communications between the various hardware components. The sonic processing system may further be equipped with software including instructions for all the steps of sonic processing including loading data, filtering in the time and space domain, performing quality control, estimating sonic velocities and dispersion curves, picking and editing arrival times.

In Step 1806 a sonic velocity model pertaining to the subterranean region is obtained. The sonic velocity model may include information from surface and borehole seismic data and/or sonic logging data recorded in one or more boreholes penetrating the subterranean region. The sonic velocity model may form an initial velocity model to be updated later in the flowchart 1800. Further the sonic velocity model may be spatially smoothly or slowly varying.

In Step 1808 a trajectory for the borehole may be obtained. The trajectory may characterize the spatial path of the borehole through the subterranean region in a first coordinate system, typically a cartesian coordinate with one axis indicating depth below a horizontal surface, such as the earth's surface, and one or more horizontal axes orthogonal to each other and to the depth axis. The trajectory may be recorded during drilling the borehole or afterwards using wireline or coil tubing conveyed survey instruments well known in the art.

In Step 1810, the sonic velocity model may be transformed from the first coordinate system into a second coordinate system. The second coordinate system may include a first axis everywhere parallel to a borehole trajectory and a second axis perpendicular to the first axis. In many cases the second axis may also lie in a vertical plane.

In Step 1812 a sonic image may be formed in the second coordinate system from the sonic velocity model in the second coordinate system and the full-waveform sonic dataset. The sonic image may be formed by performing a pre-stack depth imaging process. In some embodiments, the pre-stack depth imaging process may be Generalized Radon Transform imaging process, while in other embodiments the pre-stack depth imaging process may include a Kirchhoff migration or a Reverse-Time Migration process.

In some embodiments the formation of the sonic image may include an iterative, or recursive, process executed until a stopping criterion is met. The iterative, or recursive process may include the steps of forming a candidate sonic image in the second coordinate system from the sonic velocity model in the second coordinate system and the full-waveform sonic dataset, identifying a location of a candidate sonic reflector within the sonic image, and updating sonic velocity model based, at least in part on the location of the candidate sonic reflector. Once the stopping criterion has been met the sonic image may be designated to be the candidate sonic image satisfying the stopping criterion. In some embodiments, the stopping criterion may be based on a metric quantifying a difference between the current candidate sonic image and a candidate sonic image from a previous iteration, while in other embodiments the stopping criterion may be the completion of a predetermined maximum number of iterations.

In some embodiments forming the sonic processing system may include forming an updated sonic velocity model based, at least in part on the location of the sonic reflector transforming the updated sonic velocity model from the first coordinate system into a second coordinate system, forming an updated sonic image in the second coordinate system from the sonic velocity model in the second coordinate system and the full-waveform sonic dataset, transforming the sonic image from the second coordinate system into the first coordinate system; and identifying an updated location of the sonic reflector within the sonic image.

In Step 1814 the sonic image may be transformed from the second coordinate system into the first coordinate system and in Step 1816 a location of a sonic reflector within the sonic image may be identify, using a sonic interpretation workstation. The sonic interpretation workstation may provide access to additional information, such as well logs of different quantities, such as resistivity and gamma ray emission, to assist in the interpretation and identification. Further, the interpretation of the sonic image using the sonic interpretation workstation may provide input to identifying a preferred completion plan for the borehole based, at least in part, on the sonic image. Subsequently, the borehole may be completed guided by the preferred completion plan.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

What is claimed is:

1. A method for forming sonic images of a subterranean region, comprising:
acquiring, using a borehole sonic tool, a full-waveform sonic dataset pertaining to a borehole penetrating the subterranean region, wherein the borehole sonic tool comprises at least one source and at least one receiver;
using a sonic processing system:
receiving the full-waveform sonic dataset,
obtaining a sonic velocity model pertaining to the subterranean region,
obtaining a trajectory for the borehole, wherein the trajectory characterizes a spatial path of the borehole through the subterranean region in a first coordinate system,
transforming the sonic velocity model from the first coordinate system into a second coordinate system,
forming a sonic image in the second coordinate system from the sonic velocity model in the second coordinate system and the full-waveform sonic dataset,
transforming the sonic image from the second coordinate system into the first coordinate system; and
identifying, using a sonic interpretation workstation, a location of a sonic reflector within the sonic image.

2. The method of claim 1, further comprising, using the sonic processing system:
forming an updated sonic velocity model based, at least in part on the location of the sonic reflector;
transforming the updated sonic velocity model from the first coordinate system into a second coordinate system;
forming an updated sonic image in the second coordinate system from the sonic velocity model in the second coordinate system and the full-waveform sonic dataset;
transforming the sonic image from the second coordinate system into the first coordinate system; and
identifying an updated location of the sonic reflector within the sonic image.

3. The method of claim 1, wherein forming the sonic image comprises,
iteratively, or recursively, until a stopping criterion is met:
forming a candidate sonic image in the second coordinate system from the sonic velocity model in the second coordinate system and the full-waveform sonic dataset;
identifying a location of a candidate sonic reflector within the sonic image; and
updating sonic velocity model based, at least in part on the location of the candidate sonic reflector; and
designating the sonic image to be the candidate sonic image satisfying the stopping criterion.

4. The method of claim 3, wherein the stopping criterion is based on a metric quantifying a difference between a current candidate sonic image and a candidate sonic image from a previous iteration.

5. The method of claim 1, wherein the first coordinate system comprises a vertical axis and at least one horizontal axis and the second coordinate system comprises a first axis everywhere parallel to a borehole trajectory and a second axis perpendicular to the first axis.

6. The method of claim 1, wherein forming a sonic image comprises performing a pre-stack depth imaging process.

7. The method of claim 6, wherein performing the pre-stack depth imaging process comprises a Generalized Radon Transform.

8. The method of claim 1, wherein forming the sonic image comprises:
forming a first directional sonic image from sonic waves with a positive vector component of propagation in a direction of increasing depth along a borehole axis; and
forming a second directional sonic image from sonic waves with a negative vector component of propagation in the direction of increasing depth along a borehole axis.

9. The method of claim 8, wherein forming the first directional sonic image comprises:
determining a travel time table for a grid of image points encompassing a source location and a receiver location, wherein the grid of image points extend for a greater distance in a shallower direction along the borehole axis than in a deeper direction.

10. The method of claim 8, wherein forming the second directional sonic image comprises:
determining a travel time table for a grid of image points encompassing a source location and a receiver location, wherein the grid of image points extend for a greater distance in a deeper direction along the borehole axis than in a shallower direction.

11. The method of claim 2, determining a high-resolution model of one or more Geomechanics properties based, at least in part, on the sonic image, the updated velocity model, and a well log of one or more formation properties.

12. The method of claim 1, further comprising:
identifying a preferred completion plan for the borehole based, at least in part, on the sonic image; and
completing the borehole guided by the preferred completion plan.

13. A system for forming sonic images of a subterranean region, comprising:
a borehole sonic tool, configured to acquire a full-waveform sonic dataset pertaining to a borehole penetrating the subterranean region, wherein the borehole sonic tool comprises at least one source and at least one receiver;
a sonic processing system, configured to:
receive the full-waveform sonic dataset,
receive a sonic velocity model pertaining to the subterranean region,
receive a trajectory for the borehole, wherein the trajectory characterizes a spatial path of the borehole through the subterranean region in a first coordinate system,
transform the sonic velocity model from the first coordinate system into a second coordinate system,
form a sonic image in the second coordinate system from the sonic velocity model in the second coordinate system and the full-waveform sonic dataset,
transforming the sonic image from the second coordinate system into the first coordinate system; and
a sonic interpretation workstation, configured to identify a location of a sonic reflector within the sonic image.

14. The system of claim 13, wherein the sonic processing system is further configured to:
form an updated sonic velocity model based, at least in part on the location of the sonic reflector;
transform the updated sonic velocity model from the first coordinate system into a second coordinate system;
form an updated sonic image in the second coordinate system from the sonic velocity model in the second coordinate system and the full-waveform sonic dataset;
transform the sonic image from the second coordinate system into the first coordinate system; and
identify an updated location of the sonic reflector within the sonic image.

15. The system of claim 13, wherein the sonic processing system is configured to form the sonic image by performing steps comprising:
iteratively, or recursively, until a stopping criterion is met:
forming a candidate sonic image in the second coordinate system from the sonic velocity model in the second coordinate system and the full-waveform sonic dataset;
identifying a location of a candidate sonic reflector within the sonic image; and
updating sonic velocity model based, at least in part on the location of the candidate sonic reflector; and
designating the sonic image to be the candidate sonic image satisfying the stopping criterion.

16. The system of claim 13, wherein the first coordinate system comprises a vertical axis and at least one horizontal axis and the second coordinate system comprises a first axis everywhere parallel to a borehole trajectory and a second axis perpendicular to the first axis.

17. The system of claim 13, wherein the sonic processing system is configured to form the sonic image by performing steps comprising a performing a pre-stack depth imaging process.

18. The system of claim 13, wherein the sonic processing system is configured to form the sonic image by performing steps comprising:
forming a first directional sonic image from sonic waves with a positive vector component of propagation in a direction of increasing depth along a borehole axis; and
forming a second directional sonic image from sonic waves with a negative vector component of propagation in the direction of increasing depth along a borehole axis.

19. The system of claim 18, wherein the sonic processing system is configured to form the first directional sonic image by performing steps comprising:
determining a travel time table for a grid of image points encompassing a source location and a receiver location, wherein the grid of image points extend for a greater distance in a shallower direction along the borehole axis than in a deeper direction.

20. The system of claim 18, wherein the sonic processing system is configured to form the second directional sonic image by performing steps comprising:
determining a travel time table for a grid of image points encompassing a source location and a receiver location, wherein the grid of image points extend for a greater distance in a deeper direction along the borehole axis than in a shallower direction.
